(19) United States
(12) Patent Application Publication
(10) Pub. No.: US 2013/0084098 A1
(43) Pub. Date: Apr. 4, 2013

(54) DEVELOPING DEVICE AND CLEANING DEVICE

(71) Applicant: CANON KABUSHIKI KAISHA, Tokyo (JP)

(72) Inventors: Takayuki Kanazawa, Yokohama-shi (JP); Motoki Adachi, Ashigarakami-gun (JP); Kentaro Kawata, Suntou-gun (JP); Masanori Tanaka, Yokohama-shi (JP); Shunsuke Mizukoshi, Yokohama-shi (JP)

(73) Assignee: CANON KABUSHIKI KAISHA, Tokyo (JP)

(21) Appl. No.: 13/629,988

(22) Filed: Sep. 28, 2012

(30) Foreign Application Priority Data
Oct. 3, 2011 (JP) 2011-219361
Oct. 3, 2011 (JP) 2011-219362

(51) Int. Cl. G03G 15/08

(52) U.S. Cl. 399/103

(57) ABSTRACT

A developing device developing a latent image includes a developer bearing member configured to bear a developer, a frame member configured to rotatably support the developer bearing member, and a sealing member, provided on the frame member, including a contact portion configured to contact an end in an axial direction of the developer bearing member and a non-contact portion configured not to contact the developer bearing member, the sealing member including a cut portion provided in the non-contact portion by cutting a surface of the sealing member in a direction intersecting a rotational direction of the developer bearing member, wherein the cut portion does not connect one end and another end of the sealing member in the axial direction.

### BACKGROUND OF THE INVENTION

1. Field of the Invention

The present disclosure relates to a developing device and a cleaning device used in an image forming apparatus such as an electrophotographic printer and an electrophotographic copying machine for forming an image on a recording medium.

2. Description of the Related Art

In an image forming apparatus for forming an image on a recording medium using an electrophotographic technique, in general, a photosensitive drum serving as an image bearing member is charged by a charging unit, and a charged surface is selectively exposed to light to form an electrostatic latent image thereon. Subsequently, toner serving as developer is triboelectrically charged and then supplied to the electrostatic latent image from a developing device, thereby forming a toner image. The toner image on the surface of the photosensitive drum is transferred to a recording medium such as a sheet, and then is fixed onto the recording medium with heat and pressure. Upon transfer of the toner image, a residual transfer toner remaining on the surface of the photosensitive drum is scraped by a cleaning blade contacting the surface the photosensitive drum. This process prepares the photosensitive drum for the next image formation.

The developing device contains a black toner for monochrome image formation, and yellow, magenta, cyan, and black toners for color image formation. The toner is supplied from the developing device to an electrostatic latent image by a developing roller referred to as a rotation member. The developing roller is provided facing the electrostatic latent image.

Herein, an end of the developing roller is provided with a sealing member (hereinafter referred to as an end seal) to prevent leakage of toner to the outside through a space between an opening of a developing device frame and the developing roller. The end seal contacts a circumferential surface of the developing roller to fill the space between the developing roller and the developing device frame. The end seal is attached to the developing device frame through an adhesive member such as a double-sided tape and an adhesive agent. A liquid elastomer is often used as such an adhesive agent, which can be readily solidified. For example, Japanese Patent Application Laid-Open No. 4-9869 discusses a configuration in which an end seal bottom is attached to a frame member with a double-sided tape, and then the space between an end seal side surface and a developing device frame is filled by injecting an elastomer, thereby preventing leakage of developer to the outside of the developing device.

Meanwhile, after transfer of the toner image (developer image) to the recording medium, the residual toner remaining on the photosensitive drum is cleaned by the cleaning device. The cleaned toner is referred to as a collected toner. The collected toner is stored in a collected toner container disposed inside the cleaning device.

Here, a sealing member is used similar to the developing device to prevent leakage of the developer to the outside from a space between the photosensitive drum and a frame of the cleaning device storing the collected toner. More specifically, an end of the photosensitive drum is provided with a sealing member (hereinafter referred to as an end seal) including materials such as felt. The sealing member contacts a circumferential surface of the photosensitive drum to fill the space between the photosensitive drum and the cleaning device frame. The end seal is attached to the frame through a double-sided tape and an adhesive agent, for example.

Recently, an end seal has been expected to have higher durability as an image forming apparatus has come to have a longer life. Moreover, the end seal is expected to have higher sealability as toner has smaller particles for a high-definition image forming apparatus.

When an image forming apparatus repeatedly performs a large number of image forming processes, a physical shock during the image formation can generate the space between an end seal and an apparatus frame to which the end seal is attached. When the frame and the end seal are separated and the space is generated therebetween, there is a possibility that developer (toner) leaks from the space to the outside of the frame member.

### SUMMARY OF THE INVENTION

The present disclosure is directed to a developing device or a cleaning device having high durability with a highly durable end seal capable of reducing toner leakage.

According to an aspect disclosed herein, a developing device developing a latent image includes a developer bearing member configured to bear a developer, a frame member configured to rotatably support the developer bearing member, and a sealing member, provided on the frame member, including a contact portion configured to contact an end in an axial direction of the developer bearing member and a non-contact portion configured not to contact the developer bearing member, the sealing member including a cut portion provided in the non-contact portion by cutting a surface of the sealing member in a direction intersecting a rotational direction of the developer bearing member, wherein the cut portion does not connect one end and another end of the sealing member in the axial direction.

According to another aspect disclosed herein, a developing device developing a latent image includes a developer bearing member configured to bear a developer, a frame member configured to rotatably support the developer bearing member, and a sealing member, provided on the frame member, including a contact portion configured to contact an end in an axial direction of the developer bearing member and a non-contact portion configured not to contact the developer bearing member, the sealing member including a cut portion provided in the non-contact portion by cutting a surface of the sealing member in a direction intersecting a rotational direction of the developer bearing member, wherein the cut portion is formed to approach an upstream side of the rotational direction from the surface of the sealing member toward an inner portion of the sealing member.

According to yet another aspect disclosed herein, a cleaning device, including an image bearing member and removing a developer attached to the image bearing member, includes a frame member configured to rotatably support the image bearing member, and a sealing member, provided on the frame member, including a contact portion configured to contact an end in an axial direction of the image bearing member and a non-contact portion configured not to contact the image bearing member, the sealing member including a cut portion provided in the non-contact portion by cutting halfway through a surface of the sealing member in a direction intersecting a rotational direction of the image bearing member, wherein the cut portion does not connect one end and another end of the sealing member in the axial direction.

According to yet another aspect disclosed herein, a cleaning device, including an image bearing member and removing a developer attached to the image bearing member, includes a frame member configured to rotatably support the image bearing member, and a sealing member, provided on the frame member, including a contact portion configured to contact an end in an axial direction of the image bearing member and a non-contact portion configured not to contact the image bearing member, the sealing member including at least one cut portion provided in the non-contact portion by cutting a surface of the sealing member in a direction intersecting a rotational direction of the image bearing member, wherein the cut portion is formed to approach an upstream side of the rotational direction from the surface of the sealing member toward an inner portion of the sealing member.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles disclosed herein.

FIG. 1A is a diagram illustrating a cut part of an end seal as a comparative example, and FIGS. 1B and 1C are diagrams each illustrating a cut part of an end seal according to a first exemplary embodiment.

FIG. 2 is a diagram illustrating an image forming apparatus capable of employing the present invention.

FIG. 3 is an enlarged cross-sectional view illustrating a developing device capable of employing the present invention.

FIG. 4 is a diagram illustrating an opening of the developing device capable of employing the present invention.

FIG. 5 is a diagram illustrating an end seal according to the present invention.

FIGS. 6A, 6B, and 6C are diagrams each illustrating a position in which a cut portion is provided.

FIGS. 7A through 7D are diagrams each illustrating a case where force is applied to the end seal.

FIGS. 8A and 8B are diagrams each illustrating a depth of the cut portion.

FIG. 9 is a diagram illustrating the cut part of the end seal according to the first exemplary embodiment.

FIG. 10 is an enlarged cross-sectional view illustrating a cleaning device.

FIG. 11 is a diagram illustrating an opening of the cleaning device.

FIG. 12 is a diagram illustrating an end seal of a cleaning device according to a second exemplary embodiment.

FIG. 13A is a diagram illustrating the cut part of an end seal according to a third exemplary embodiment, and FIGS. 13B and 13C are diagrams each illustrating the cut part of an end seal as a comparative example.

FIG. 14 is a diagram illustrating the cut part of an end seal according to a fourth exemplary embodiment.

FIG. 15 is a diagram illustrating the cut part of the end seal according to the fourth exemplary embodiment.

FIG. 16 is a diagram illustrating the cut part of the end seal according to the fourth exemplary embodiment.

### DESCRIPTION OF THE EMBODIMENTS

Various exemplary embodiments, features, and aspects of the invention will be described in detail below with reference to the drawings.

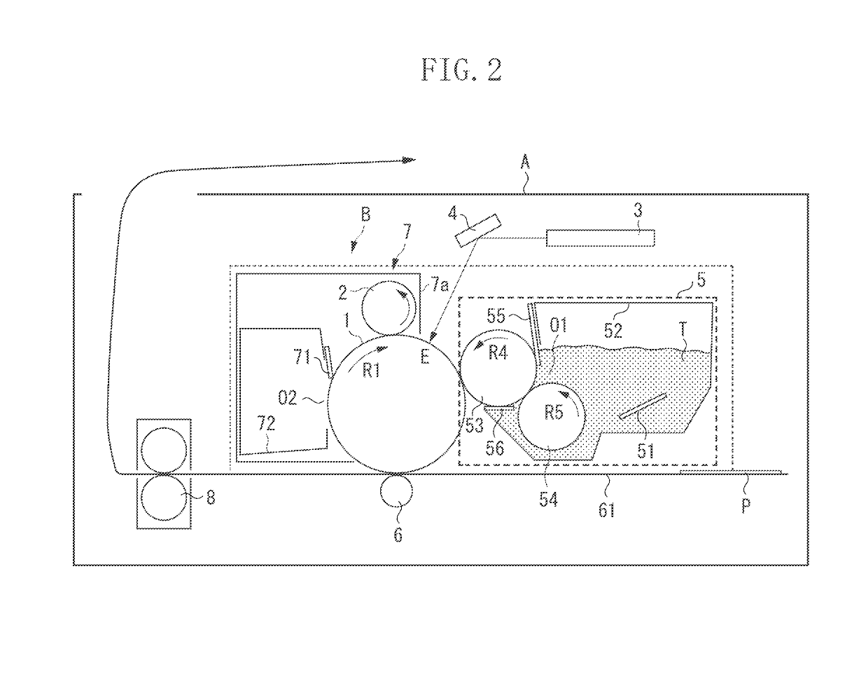

A first exemplary embodiment is described in detail with reference to FIG. 2. Sizes, materials, shapes and relative arrangements of components described in the present exemplary embodiment can be changed as appropriate according to various conditions and a configuration of a device to which the present invention is applied. The scope of the present invention is not limited to the following exemplary embodiments. In the present exemplary embodiment, a monochrome laser printer is described as an example of the simplest image forming apparatus. However, the present exemplary embodiment may also be applied to tandem type and rotary type color laser printers.

FIG. 2 is a diagram schematically illustrating a configuration of an image forming apparatus A employing an electrophotographic process according to the present invention. The image forming apparatus A forms an image on a sheet-like recording medium P serving as a recording medium based on electrical image signals input from a host device (not illustrated) to a controller unit (control unit: central processing unit (CPU) (not illustrated). The host device is, for example, an image reader (document image reading apparatus) and a personal computer.

The controller unit, between the host device and an operation unit of the image forming apparatus A, transfers various electrical information. Moreover, the controller unit comprehensively controls image forming operations of the image forming apparatus A according to a predetermined control program.

The image forming apparatus A of the present exemplary embodiment includes a photosensitive drum 1 serving as an image bearing member for bearing an electrostatic latent image on a surface thereof. Moreover, the image forming apparatus A includes a charging roller 2, an image exposing unit 3, a developing device 5, a transfer roller 6 serving as a transfer unit, a fixing unit 8, and a cleaning unit each of which serves as a process unit acting on the photosensitive drum 1.

In the present exemplary embodiment, the cleaning unit includes a cleaning blade 71 and a developer container 72. The cleaning blade 71 scrapes toner attached to the photosensitive drum 1 by contacting the photosensitive drum 1. The developer container 72 stores the toner removed by the cleaning blade 71 from the photosensitive drum 1.

The cleaning blade 71, the developer container 72, the photosensitive drum 1, and the charging roller 2 integrally form a cleaning device 7.

In the present exemplary embodiment, moreover, the cleaning device 7 and the developing device 5 are combined, so that a process cartridge B is formed. The process cartridge B is detachable from the image forming apparatus A.

An image forming operation of the image forming apparatus A is now described. When an image formation start signal is input, a controller unit (not illustrated) drives a main motor (not illustrated). Thus, the photosensitive drum 1 is driven at a predetermined process speed in a direction indicated by an arrow R1 illustrated in FIG. 2. The driving of the photosensitive drum 1 causes the charging roller 2 serving as a charging unit to be rotationally driven, and the charging roller 2 applies a predetermined charging bias to the photosensitive drum 1 such that a surface potential of the photosensitive drum 1 is charged with a predetermined dark potential. The charging roller 2 is a conductive rubber roller for uniformly charging a surface of the photosensitive drum 1.

The image exposing unit 3 outputs laser light L which is modulated according to an image signal, and the light L scans an exposure region E on a charge processing surface of the photosensitive drum 1 through a reflection mirror 4. A potential of the area exposed to the light L becomes a predetermined light potential, and then an electrostatic latent image corresponding to an image is formed on the surface of the photosensitive drum 1. The image exposing unit 3 uses a laser scanner unit.

The developing device 5 visualizes an electrostatic latent image formed on a surface of the photosensitive drum 1 as a developer image (toner image). The developing device 5 includes a developing roller 53 serving as a developer bearing member. The developing roller 53 receives a driving force, and is rotationally driven at a predetermined speed in a direction indicated by an arrow R4 in contact with the photosensitive drum 1. Simultaneously, a predetermined direct current voltage as a developer bias is applied to the developing device 5. Accordingly, the electrostatic latent image is developed as a toner image (developer image) by the developing device 5. The developing roller 53 is a conductive rubber roller.

The developing device 5 includes a developer container 52 for storing a non-magnetic black toner having a negative charging property as a developer T. The developer container 52 supports an agitation blade 51 for agitating the toner T, and a developer coating roller (hereinafter referred to as a coating roller) 54 for supplying toner by contacting the developing roller 53. Moreover, the developer container 52 supports a regulation blade 55. The regulation blade 55 regulates a toner layer thickness by rubbing a toner layer on the developing roller 53 with a leading end thereof. The coating roller 54 is a developer coating member. In the present exemplary embodiment, the coating roller 54 is a urethane sponge roller. The regulation blade 55 is a developer layer regulating member, and is made of phosphor bronze.

The coating roller 54 is rotationally driven in a direction indicated by an arrow R5. The rotation of the coating roller 54 coats toner on a circumference of the developing roller 53 being rotated. The coated toner is regulated by the regulation blade 55. Meanwhile, toner not supplied to the electrostatic latent image is conveyed and returned to the developer container 52 by continuous rotation of the developing roller 53. The toner is removed from a surface of the developing roller 53 by the coating roller 54, and then is coated on the surface of the developing roller 53 again by the coating roller 54. This operation is repeated, so that the electrostatic latent image formed on a surface of the photosensitive drum 1 is developed.

In the present exemplary embodiment, the photosensitive drum 1 and the developing roller 53 shift from a separation state to a contact state by a contact/separation mechanism (not illustrated) at the beginning of the image forming operation. Moreover, the photosensitive drum 1 and the developing roller 53 shift from a contact state to a separation state at the end of the image forming operation. The photosensitive drum 1 and the developing roller 53 start rotating at the beginning of the image forming operation, and stop rotating at the end of the image forming operation. These operations can lead to generation of space between the developer container 52 and an end seal 562.

The developer container 52 serves as a frame of the developing device 5, and is a horizontally-oriented container which extends in a longitudinal direction (axial direction) of the developing roller 53. In the following description, the longitudinal direction of the developing roller 53 may be simply referred to as a longitudinal direction, and a direction perpendicular to the longitudinal direction may be referred to as a lateral direction. The longitudinal direction is a direction parallel to an axis line of the developing roller 53, and is a direction substantially parallel to an axis line of the photosensitive drum 1.

Inside the developer container 52, developer (toner) is stored. The developer container 52 includes an opening O1 formed along a longitudinal direction in a lower portion thereof. The developing roller 53 is positioned in the opening O1. The developer container 52 rotatably supports the developing roller 53 through bearing members (not illustrated) attached on both sides thereof in the longitudinal direction.

The regulation blade 55 has a base which is fixed to an upper end of the opening O1, so that the regulation blade 55 is disposed on the developer container 52.

A toner image developed on the photosensitive drum 1 is transferred to a recording medium P such as a sheet in a nip portion between the photosensitive drum 1 and the transfer roller 6. The recording medium P is synchronized with the toner image formed on the surface of the photosensitive drum 1, and is fed to the nip portion between the photosensitive drum 1 and the transfer roller 6 by a feeding roller (not illustrated) and a conveyance roller (not illustrated). The transfer roller 6 transfers the toner image formed on the surface of the photosensitive drum 1 to the recording medium P. When the recording medium P is nipped and conveyed through the transfer nip portion, a transfer bias having a polarity opposite to that of the toner is applied to the transfer roller 6, thereby electrostatically transferring images on the surface of the photosensitive drum 1 to a surface of the recording medium P in sequence.

Subsequently, the recording medium P is separated from a surface of a belt 61 and fed to the fixing unit 8, so that the recording medium P is heated and pressed in a fixing nip portion. Accordingly, the toner image is fixed onto the recording medium P. The recording medium P is conveyed from the fixing unit 8 and discharged to a discharge unit (not illustrated) as an image formed matter.

The cleaning device 7 removes a residual transfer toner remaining on a surface of the photosensitive drum 1 after a toner image is transferred from the photosensitive drum 1 to the recording medium P. The cleaning device 7 includes the cleaning blade 71 generally made of a material having flexibility such as urethane rubber. After transfer of a toner image to the recording medium P, the residual transfer toner remaining on the photosensitive drum 1 is removed by the cleaning blade 71 being in contact with the photosensitive drum 1. The removed toner is stored in the developer container 72.

The developer container 72 is a horizontally-oriented container which extends in an axial direction (longitudinal direction) of the photosensitive drum 1. The developer container 72 forms one portion of a frame 7a of the cleaning device 7. The developer container 72 stores developer (toner) inside. The developer container 72 includes an opening O2 extending in a longitudinal direction. The photosensitive drum 1 is positioned in the opening O2, and is arranged parallel to the longitudinal direction. The frame 7a of the cleaning device 7 has bearing members (not illustrated) attached to both sides thereof in a longitudinal direction. The frame member 7a rotatably supports the photosensitive drum 1 through these bearing members.

The cleaning blade 71 has a base which is fixed to an upper end of the opening O2 formed on the developer container 72.

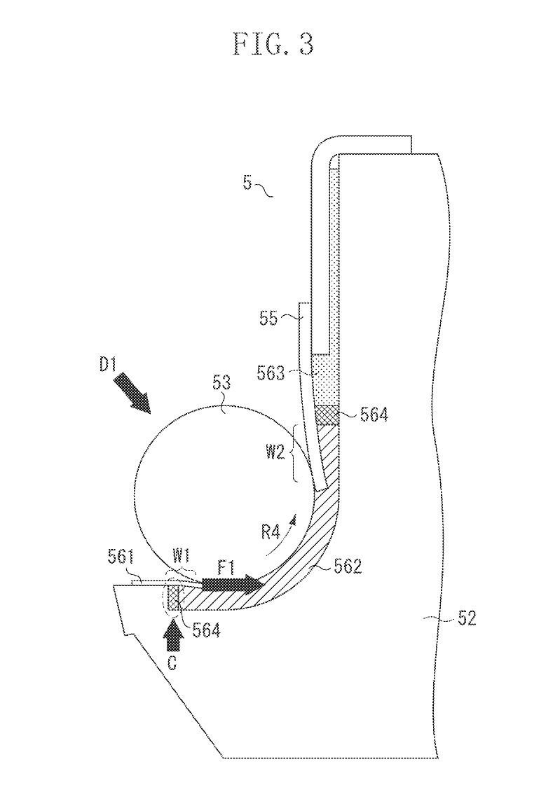

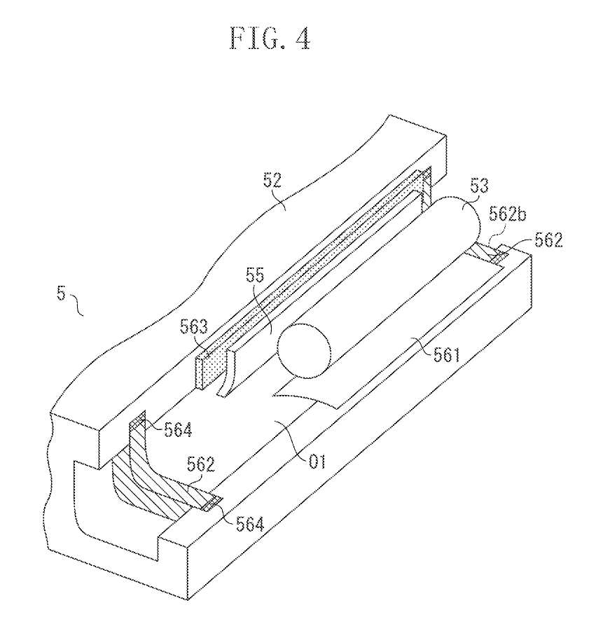

Next, an entire sealing member is described with reference to FIGS. 3 and 4, which is provided in the developing device 5. FIG. 3 is an enlarged view of the developing device 5, and FIG. 4 is an enlarged view of the periphery of the opening O1 of the developing device 5. FIG. 4 is a perspective view as seen from a direction indicated by an arrow D1 illustrated in FIG. 3. A positional relation of each of components is illustrated while a component not needed for description of the sealing member is omitted.

The developing device 5 is provided with sealing members to suppress leakage of toner from the developing device 5 to the outside. A blade back seal 563, serving as one of the sealing members, is provided to fill a space between the regulation blade 55 and a frame (developer container 52) of the developing device 5. The blade back seal 563 is disposed in an upper portion of the opening O1 of the developer container 52 such that blade back seal 563 is positioned on the back of the regulation blade 55. In the present exemplary embodiment, the blade back seal 563 is a urethane sponge sheet which is attached using double-sided tape.

A blowout prevention sheet 561, serving as one of the sealing members, is attached to the developer container 52. The blowout prevention sheet 561 prevents developer from blowing from an entire space generated between a lower portion of the developing roller 53 in the longitudinal direction. The blowout prevention sheet 561 is made of a material having flexibility such as a polyester film. The blowout prevention sheet 561 is attached to a lower portion of the opening O1 of the developer container 52. One end of the blowout prevention sheet 561 is a free end. One portion of this free end is in contact with a circumferential surface of the developing roller 53 in the whole longitudinal direction. Since the first end of the blowout prevention sheet 561 is the free end, toner sealability is maintained on a downstream side in a rotational direction of the developing roller 53 without regulating toner on an upstream side in the rotational direction. Further, a second end of the blowout prevention sheet 561 in a lateral direction is a fixed end which is directly attached to the developer container 52 through a double-sided tape.

The end seal 562, serving as one of the sealing members, is attached to the developer container 52. The end seal 562 is positioned on each of both sides of the opening O1 in a longitudinal direction. These two end seals 562 on the both sides of the opening O1 of the developer container 52 contact respective first and second ends in a longitudinal direction of the developing roller 53. The end seal 562 fills space generated between the developing roller 53 and the developer container 52 to suppress leakage of the toner carried by the developing roller 53 to the outside of the developing device 5.

The end seal 562 is arranged in contact with the blade back seal 563. Moreover, the blowout prevention sheet 561 extends in a longitudinal direction to a position in which the blowout prevention sheet 561 and the end seal 562 overlap each other such that the toner stored in the developer container 52 is not leaked from the opening O1.

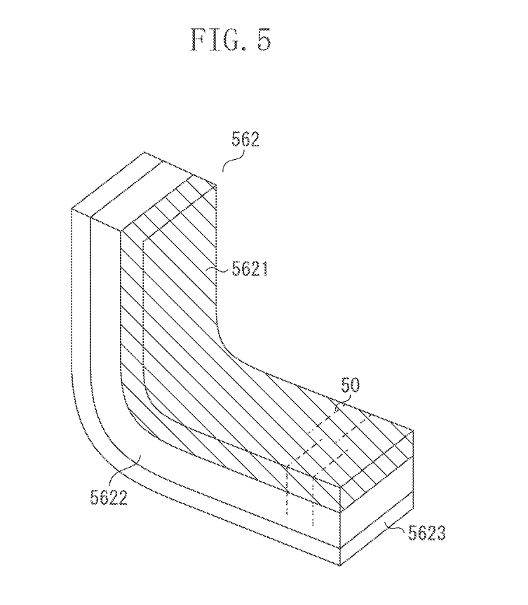

The end seal 562 is described in further detail with reference to FIG. 5 illustrating the end seal 562 as seen from obliquely above. The end seal 562 includes three separate layers which are composed of a felt implanted layer 5621, a sponge foam material layer 5622, and a double-sided adhesive sheet 5623 including a double-sided adhesive seal. The double-sided adhesive sheet 5623 is bonded to a contact surface contacting a frame of the developing device 5. Both of the felt implanted layer 5621 and the sponge foam material layer 5622 have flexibility and expandability-contractibility. The felt implanted layer 5621, the sponge foam material layer 5622, and the double-sided adhesive sheet 5623 have thicknesses of 700 μm, 2000 μm, 100 μm, respectively.

In the present exemplary embodiment, the end seal 562 has a cut part (cut portion) 50 to enhance an effect of suppressing toner leakage. A function of the cut portion 50 is described below.

Lastly, an injection seal 564 is described. Generally, an end seal is directly arranged in close contact with a frame body (developer container) of a developing device or a blade back seal so that toner is not leaked from the developing device to the outside. In the present exemplary embodiment, on the other hand, the injection seal 564 is injected into the developer container 52 and a boundary area (an area C illustrated in FIG. 3) between the blade back seal 563 and the end seal 562, thereby further enhancing toner sealability by the end seal 562. In the present exemplary embodiment, the end seal 562 and the blade back seal 563 are attached to predetermined positions of the developer container 52, and then a liquid elastomer serving as the injection seal 564 is injected, which is readily solidified.

However, repetitive image forming operations may cause a crack on the injection seal 564, and toner leaks from the space of the crack in spite of injection of the injection seal 564 into the area C. In addition to the case of the crack generated on the injection seal 564, the end seal 562 and the injection seal 564 may be separated, and the injection seal 564 and the developer container 52 may be separated. These cases may generate the space in the area C. Then, separation of the end seal 562 from the developer container 52 leads to the possibility of toner leakage from the developer container 52.

Such a phenomenon occurs due to a pull of the end seal 562 when the photosensitive drum 1 contacts the developing roller 53 by the contact/separation mechanism, and when the developing roller 53 begins to rotate.

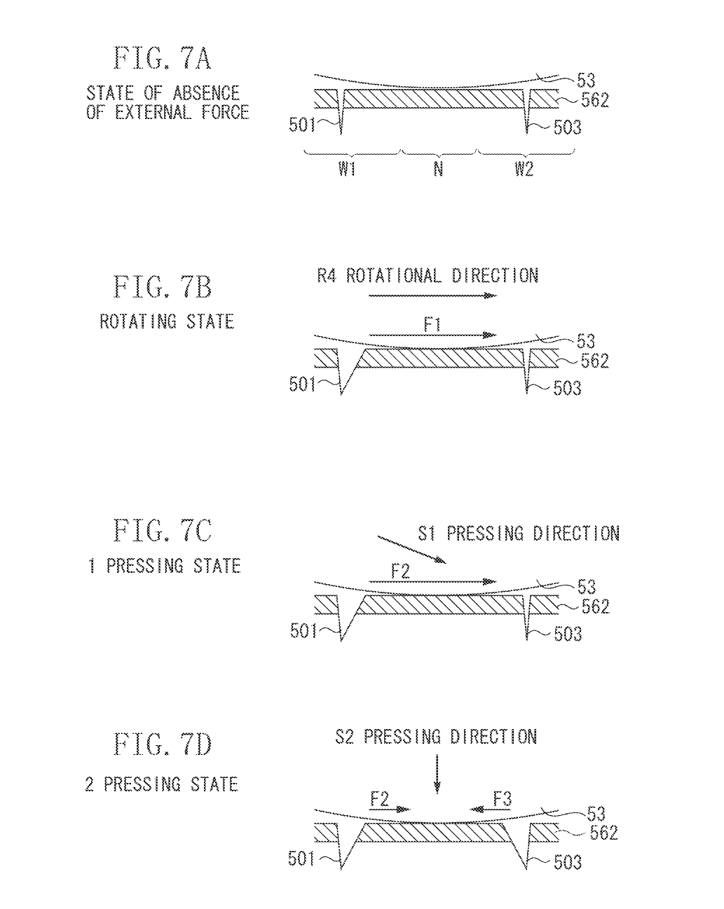

The end seal 562 is pulled by a force (hereinafter referred to as a pulling force) toward several directions depending on situations. The different situations are described with reference to FIGS. 7A through 7D each of which is an enlarged view of the developing roller 53 and the end seal 562.

As illustrated in FIG. 7B, when the developing roller 53 begins to rotate, a pulling force F1 applied to the end seal 562 is generated in a direction similar to a rotational direction R4 of the developing roller 53. The pulling force F1 is generated by a friction force generated between the developing roller 53 and the end seal 562.

On the other hand, when the photosensitive drum 1 and the developing roller 53 contact each other, pulling forces applied to the end seal 562 are generated in different directions depending on directions in which the photosensitive drum 1 presses the developing roller 53. For example, as illustrated in FIG. 7C, when the photosensitive drum 1 presses the developing roller 53 in a pressing direction S1, that is, when the photosensitive drum 1 obliquely presses the developing roller 53 with respect to the end seal 562, a pulling force F2 is generated in one direction.

On the other hand, when the photosensitive drum 1 vertically presses the developing roller 53 (in a pressing direction S2) with respect to the end seal 562 as illustrated in FIG. 7D, both of the pulling force F2 and a pulling force F3 are generated. The pulling force F3 is generated in a direction opposite to the pulling force F2.

Herein, among those pulling forces, the pulling force F1 exerts significant influence on the end seal 562 in particular. The pulling force F1 is generated when the developing roller 53 begins to rotate. In the following study, action of the pulling force F1 at the beginning of rotation of the developing roller 53 is first considered, that is, a case of FIG. 7B is considered. Action of the other pulling forces is described separately.

The pulling force F1 should not be propagated to the area C to suppress toner leakage from a boundary area between the end seal 562 and the developer container 52, that is, to suppress toner leakage from the area C illustrated in FIG. 3.

According to the study by the inventor of the present invention, the cut portion 50 is provided on a surface of the end seal 562 as illustrated in FIG. 5 such that the pulling force F1 is not applied to the area C serving as a boundary between the end seal 562 and the developer container 52. When the pulling force F1 is applied to the end seal 562, an opening of the cut portion 50 opened, thereby suppressing propagation of the pulling force F1 to the area C (see FIG. 3). Consequently, the end seal 562 and the developer container 52 are prevented from having space therebetween.

Based on such results, selection of a suitable configuration of the cut portion 50 was studied. A result of the study is described as follows.

### Study of a Position of a Cut Portion

Table 1 illustrates a result of the study regarding a relationship between a position in which a cut portion is provided and the presence or absence of space generated on an end seal in the area C (see FIG. 3).

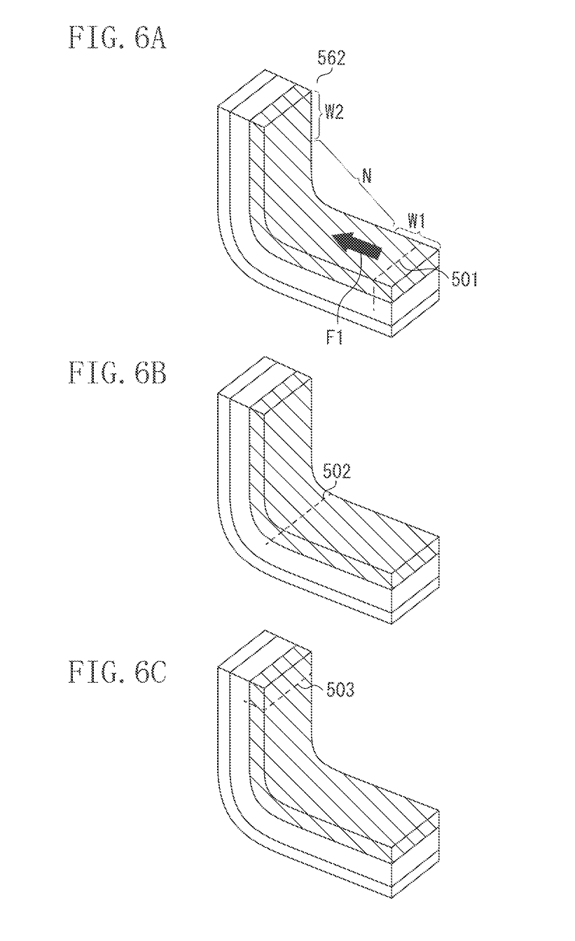

TABLE 1
Presence or absence of space on an end seal in an area C

| Cut Pattern | Space is not generated on end seal |
|---|---|
| FIG. 6A | NO |
| FIG. 6B | YES |
| FIG. 6C | YES |

NO: Space is not generated on an end seal in an area C.
YES: Space is generated on an end seal in an area C.

Herein, three cut patterns as illustrated in FIGS. 6A, 6B, and 6C were used as study examples. In each of FIGS. 6A, 6B, and 6C, a cut portion is formed by cutting a surface of the end seal 562 in a direction intersecting a rotational direction of the developing roller 53. Each of these cut portions is formed in a different position. These patterns illustrated in FIGS. 6A, 6B, and 6C are referred to as cut patterns 6A, 6B, and 6C, respectively, for the sake of convenience.

In the cut pattern 6A illustrated in FIG. 6A, a cut portion 501 is provided in an upstream non-contact portion W1. The non-contact portion W1 is positioned on an upstream side in the rotational direction of the developing roller 53 relative to a contact nip portion (contact portion) N of the end seal 562 contacting an end of the developing roller 53. The upstream non-contact portion W1 is positioned where it does not contact the developing roller 53.

In the cut pattern 6B illustrated in FIG. 6B, a cut portion 502 is provided within the contact nip portion N of the end seal 562 contacting an end of the developing roller 53. In the cut pattern 6C illustrated in FIG. 6C, a cut portion 503 is provided in a downstream non-contact portion W2. The downstream non-contact portion W2 is positioned on a downstream side in the rotational direction of the developing roller 53 relative to the contact nip portion N. The downstream non-contact portion W2 is positioned where it does not contact the developing roller 53.

In the area C, the presence or absence of space generated in the end seal 562 was evaluated by actually attaching the end seal 562 having a cut portion to an image forming apparatus, and then checking the actual image forming apparatus after a predetermined number of sheets passed therethrough. In Table 1, “NO” indicates a case where space is not generated in the area C, whereas “YES” indicates a case where space is generated. As a result of the study, the cut pattern 6A in which the cut portion 501 is provided in the upstream non-contact portion W1 of the end seal 562 (see FIG. 6A) was the most effective.

Based on the study, therefore, in the rotational direction of the developing roller 53, a cut portion can be formed in a position on an upstream side in the rotational direction of the developing roller 53.

A mechanism for this result is described with reference to FIGS. 7A through 7D. The end seal 562 illustrated in FIGS. 7A through 7D has a cut portion 501 and a cut portion 503 provided in the upstream non-contact portion W1 and the downstream non-contact portion W2, respectively, for the sake of description. FIG. 7A illustrates a case where a pulling force is not applied to the end seal 562. The cut portions 501 and 503 remain closed when the pulling force is not applied as illustrated in FIG. 7A. On the other hand, when rotation of the developing roller 53 causes the pulling force F1 to act as illustrated in FIG. 7B, an opening manner of each of the cut portions 501 and 503 differs depending on a position thereof.

The developing roller 53 and the contact nip portion N of the end seal 562 are considered to be areas which undergo a direct action of the pulling force F1. When the pulling force F1 acts, the end seal 562 is stretched in the upstream non-contact portion W1 on a starting-point side of the pulling force F1, so that an opening of the cut portion 501 formed in the upstream non-contact portion W1 opens. On the other hand, a shape of the cut portion 503 in the downstream non-contact portion W2 remains almost unchanged. The downstream non-contact portion W2 is provided in an ending-point side of the pulling force F1. Therefore, by providing a cut portion in an area in which the end seal 562 is stretched, in other words, by providing a portion for releasing the pulling force F1, propagation of the pulling force F1 to a portion in the area C illustrated in FIG. 3 can be prevented.

Generally, the kinetic friction force is smaller than the static friction force. Accordingly, a friction force generated between the developing roller 53 and the end seal 562 is the maximum when the developing roller 53 begins to rotate, whereas the friction force decreases when rotating speed of the developing roller 53 becomes constant. In other words, the pulling force F1 is also the maximum when the developing roller 53 begins to rotate, whereas the pulling force F1 decreases when rotation of the developing roller 53 becomes constant. Therefore, an opening of the cut portion 501 once becomes wide open at the beginning of rotation of the developing roller 53. Then, when the rotation of the developing roller 53 becomes constant, owing to expandability-contractibility of the felt implanted layer 5621 and the sponge foam material layer 5622, a shape of the cut portion 501 returns to a former state which is prior to application of the pulling force F1.

Accordingly, when a printing operation is repeatedly performed, the repeatedly generated pulling force F1 can be released every time printing operation is carried out.

As illustrated in FIGS. 7C and 7D, there are cases where a pulling force is applied to the end seal 562 by pressing the developing roller 53 by the photosensitive drum 1. In such cases, the pulling force F2 can be applied in a direction similar to the pulling force F1 as illustrated in FIG. 7C, or a pulling force can be applied in a direction opposite to the pulling force F1. Moreover, both of the pulling forces F2 and F3 can be applied as illustrated in FIG. 7D, where the pulling force F2 is applied in the direction similar to the pulling force F1 and the pulling force F3 is applied in the direction opposite to the pulling force F1. If the pulling force F3 in the direction opposite to the pulling force F1 acts, generation of space between the end seal 562 and the developer container 52 can be suppressed by providing the cut portion 503 in an area of the downstream non-contact portion W2. The area of the downstream non-contact portion W2 is positioned on a downstream side relative to a contact portion in which the end seal 562 contacts the developing roller 53. If both of the pulling forces F2 and F3 act as illustrated in FIG. 7D, the cut portions 501 and 503 in the upstream non-contact portion W1 and downstream non-contact portion W2 of the end seal 562 can be effective to suppress generation of the space. A plurality of cut portions may be provided.

### (Evaluation of a Depth of a Cut Portion to be Formed)

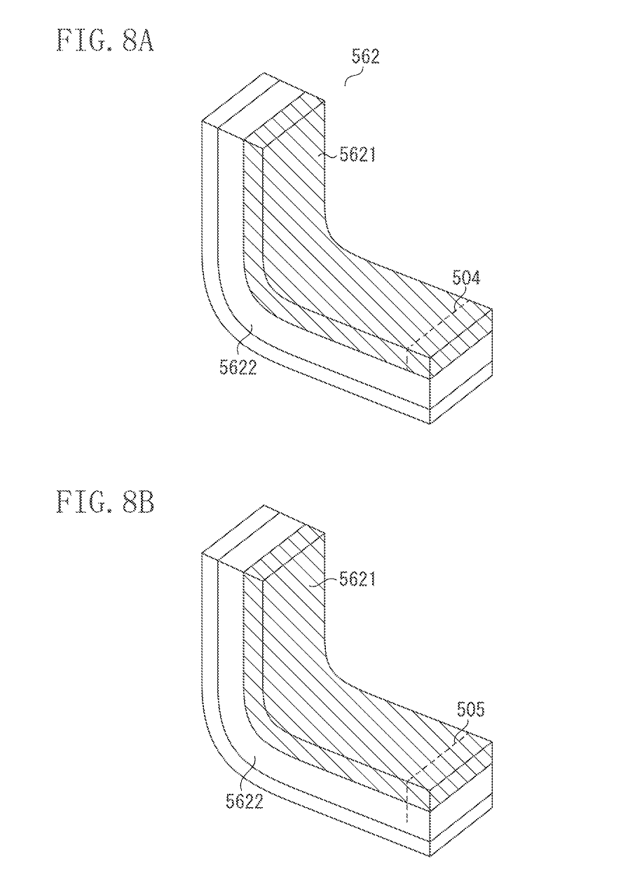

Table 2 illustrates a result of a study, based on a comparison of cut patterns illustrated in FIGS. 8A and 8B, regarding a relationship between a depth of a cut portion formed on the end seal 562 and the presence or absence of space generated in the area C. In the cut pattern illustrated in FIG. 8A, a depth of a cut portion 504 is within a range of the felt implanted layer 5621 serving as a top layer of the end seal 562. In the cut pattern illustrated FIG. 8B, a cut portion 505 is formed up to the sponge foam material layer 5622 serving as a bottom layer of the end seal 562. In each of the cut patterns illustrated in FIGS. 8A and 8B, the presence or absence of space in a portion of the area C is evaluated by a method similar to the evaluation method used in Table 1.

TABLE 2
Presence or absence of space generated in an end seal member
in an area C

| Cut Pattern | Space is not generated on end seal |
|---|---|
| FIG. 8A | NO |
| FIG. 8B | NO |

NO: Space is not generated on an end seal in an area C.

According to the evaluation result, each of the cut patterns illustrated in FIGS. 8A and 8B is sufficient to suppress generation of space on an end sealing member in the area C. Thus, depths of the cut portions provided up to both of the felt implanted layer 5621 and the sponge foam material layer 5622 were effective. However, the cut portion 505 provided up to the sponge foam material layer 5622 (see FIG. 8B) opened wider when the pulling force F1 (see FIG. 7B) was applied. As a result, propagation of the pulling force F1 in the area C (see FIG. 3) is more unlikely. Based on the study, therefore, the cut portion provided up to the sponge foam material layer 5622 can be more effective in a case of dealing with a stronger impact or a printing operation for a longer life.

### (Evaluation of a Width of a Cut Portion)

Moreover, the inventor of the present invention studied a suitable condition for a width of a cut portion to be formed on the end seal 562. Such study is described as follows.

In the previous study, when the cut portion is provided on the end seal 562, there were cases where toner leaked along the cut portion.

As a result of the study by the inventor of the present invention, a cut portion of the end seal 562 is formed such that a first end 562a and a second end 562b of the end seal 562 are not connected, and such an arrangement is effective to prevent a phenomenon of toner leakage. The study is described in detail with reference to Table 3.

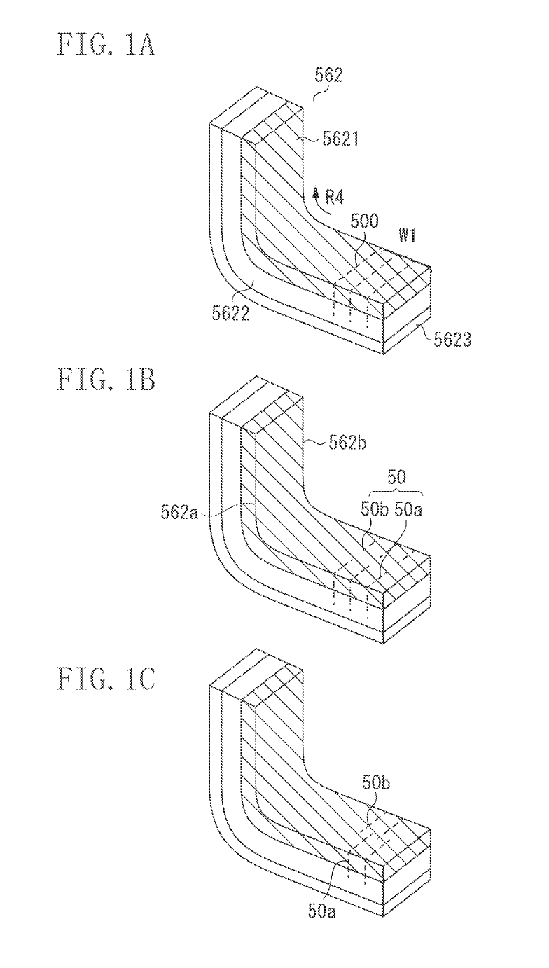

TABLE 3
Evaluation of toner leakage along a cut portion

| Cut Pattern | Toner leakage occurs along cut portion |
|---|---|
| FIG. 1A | YES |
| FIG. 1B | NO |
| FIG. 1C | NO |

NO: Toner leakage does not occur along a cut portion.
YES: Toner leakage occurs along a cut portion.

Table 3 illustrates a result of the study on whether toner leakage occurs along a cut portion in three cut patterns each having a different width of the cut portion formed on the end seal 562.

The cut patterns used for the study are illustrated in FIGS. 1A, 1B, and 1C. These patterns illustrated in FIGS. 1A, 1B, and 1C are referred to as cut patterns 1A, 1B, and 1C, respectively, for the sake of convenience. In the cut pattern 1A illustrated in FIG. 1A, a cut portion 500 is formed by cutting a surface of the end seal 562. The cut portion 500 extends in a direction intersecting a rotational direction of the developing roller 53, and connects the first end 562a and the second 562b in a longitudinal direction of the developing roller 53.

In the cut pattern 1B illustrated in FIG. 1B, a cut portion is formed only on an end of the end seal 562. More specifically, the end seal 562 includes one cut portion end 50a and another cut portion end 50b as a cut portion 50. The one cut portion end 50a is provided on a first end 562a of the end seal 562, whereas another cut portion end 50b is provided on a second end 562b of the end seal 562. Each of the one cut portion end 50a and another cut portion end 50b is a cut part formed by cutting a surface of the end seal 562 in a direction intersecting a rotational direction of the developing roller 53. In the present exemplary embodiment, a cut part is formed substantially parallel to a longitudinal direction of the developing roller 53.

The one cut portion end 50a is formed by cutting halfway through a surface of the end seal 562 from the first end 562a to the second end 562b. The another cut portion end 50b is formed by cutting halfway through a surface of the end seal 562 from the second end 562b to the first end 562a. More specifically, the one cut portion end 50a and another cut portion end 50b serving as the cutting portion 50 are configured such that the first end 562a and the second end 562b of the end seal 562 in a longitudinal direction of the developing roller 53 are not connected.

In the cut pattern 1C illustrated in FIG. 1C, one cut portion end 50a and another cut portion end 50b are alternately provided. More specifically, in a rotational direction of the developing roller 53, the one cut portion end 50a and another cut portion end 50b are provided in different positions, and the one cut portion end 50a and another cut portion end 50b are alternately arranged. Accordingly, each of the cut portions is provided across a large area along a longitudinal direction of the developing roller 53. More specifically, even if an area in which the one cut portion end 50a is formed and an area in which another cut portion end 50b is formed overlaps each other, the first end 562a and the second end 562b of the end seal 562 are not connected by each of the cut portions 50a and 50b.

Based on such study results, a cut portion is formed in the upstream non-contact portion W1 and is provided with a depth that reaches the sponge foam material layer 5622 in any of the cut patterns 1A, 1B, and 1C.

Similar to the above evaluation, a method for evaluating the cut patterns 1A, 1B, and 1C is performed by actually attaching the processed end seal 562 to an image forming apparatus, and then checking the actual image forming apparatus after a predetermined number of sheets passed therethrough. In Table 3, “NO” indicates a case where toner leakage did not occur along a cut portion, whereas “YES” indicates a case where toner leakage occurred along a cut portion. As a result, the cut pattern 1B (see FIG. 1B) and the cut pattern 1C (see FIG. 1C) are able to prevent the toner leakage along the cut portions. Space in the area C (see FIG. 3) was not generated in any of these cut patterns.

Therefore, when the cut portion did not connect the first end 562a and the second end 562b of the end seal 562, toner leakage is suppressed without an adverse effect. Since the cut pattern 1C has a cut portion in a large area compared to the cut pattern 1B, an opening of the cut portion became wider open when a pulling force was applied to the end seal 562. Consequently, suppression of the pulling force propagation was confirmed. Accordingly, the cut pattern 1C is able to suppress toner leakage for a longer term than the cut pattern 1B.

Based on such results, in the present exemplary embodiment, a configuration of the cut pattern 1C illustrated in FIG. 1C is selected as a cut portion to be formed on the end seal 562. As a result, a high-durability end seal capable of reducing occurrences of toner leakage is provided, and durability of the developing device is enhanced. The cut pattern 1B illustrated in FIG. 1B may also be selected as long as a cut portion formed on the end seal 562 does not connect the first end 562a and the second end 562b of the end seal 562.

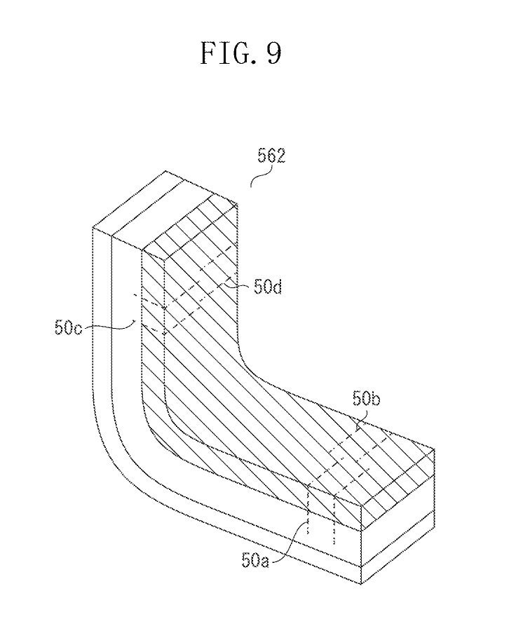

As described, there are cases where the developing roller 53 is obliquely pressed to the photosensitive drum 1, so that the pulling force F3 is applied to the end seal 562 toward a downstream side in a rotational direction of the developing roller 53 (see FIG. 7D). In such a case, a cut portion can be provided in the downstream non-contact portion W2. Moreover, cut portions may be provided in both of the upstream non-contact portion W1 and the downstream non-contact portion W2. For example, FIG. 9 illustrates a configuration in which the one cut portion end 50a and another cut portion end 50b are provided in the upstream non-contact portion W1, whereas one cut portion end 50c and another cut portion end 50d are provided in the downstream non-contact portion W2.

In the present exemplary embodiment, moreover, the injection seal 564 is injected into a boundary area between the developer container 52 and the end seal 562 as illustrated in FIG. 3 to block the space between a frame (developer container 52) of the developing device 5 and the end seal 562. However, the cut portion 50 may be formed on the end seal 562 even if the injection seal 564 is not used.

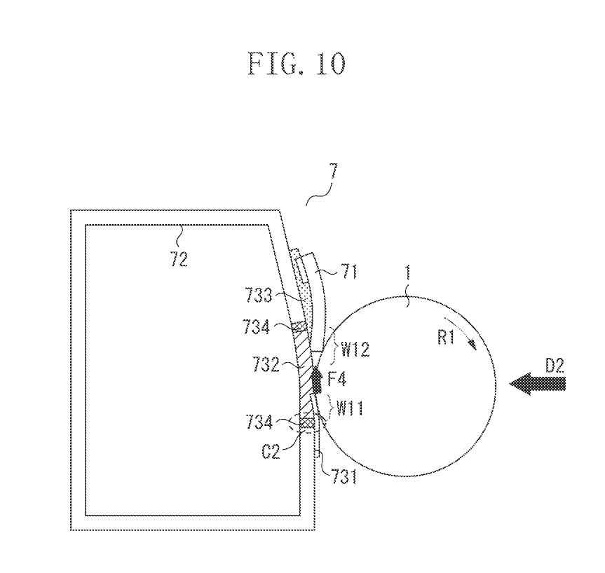

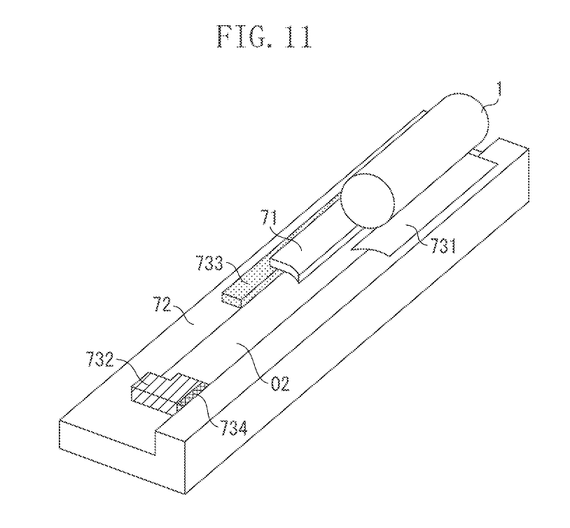

A second exemplary embodiment using an end seal of the present invention is described. In the first exemplary embodiment, the present invention was applied to the end seal 562 of the developing device 5. In the second exemplary embodiment, the present invention is applied to an end seal 732 of a cleaning device 7. A configuration and an image forming operation of an image forming apparatus according to the second exemplary embodiment are similar to those of the image forming apparatus according to the first exemplary embodiment. An entire sealing member is described in detail with reference to FIG. 10 illustrating an enlarged view of the cleaning device 7 and FIG. 11 illustrating a periphery of an opening O2 of a developer container 72. FIG. 11 is a perspective view as seen from a direction indicated by an arrow D2 illustrated in FIG. 10. An entire sealing member 73 provided on the cleaning device 7 is now described in detail.

A blade back seal 733, serving as one of sealing members, fills a space between a cleaning blade 71 and a frame (developer container 72) of the cleaning device 7. The blade back seal 733 is disposed in an upper portion of the opening O2 of the developer container 72 such that the blade back seal 733 is positioned on a back side of the cleaning blade 71. In the present exemplary embodiment, the blade back seal 733 includes a urethane sponge sheet which is attached using double-sided tape.

A blowout prevention sheet 731, serving as one of the sealing members, is attached to prevent toner from blowing from the space generated between a lower portion of a photosensitive drum 1 and the opening O2. The space is generated across the entire longitudinal direction. The blowout prevention sheet 731 is made of a material having flexibility such as a polyester film. The blowout prevention sheet 731 is attached to a lower portion of the opening O2 of the developer container 72. The blowout prevention sheet 731 has a first end in a lateral direction thereof, and the first end is a free end. One portion of this free end is in contact with a circumferential surface of the photosensitive drum 1 across the longitudinal direction. Since the first end of the blowout prevention sheet 731 is the free end, toner sealability is maintained on a downstream side in a rotational direction of the photosensitive drum 1 without regulating toner on an upstream side in the rotational direction. Moreover, the blowout prevention sheet 731 has a second end which is a fixed end directly attached to the developer container 72 through a double-sided tape.

The end seal 732, serving as one of the sealing members, is attached to the developer container 72 such that the end seal 732 is positioned on each of both ends of the opening O2 in a longitudinal direction. The end seals 732 fills the space between the developer container 72 and the photosensitive drum 1 by contacting a circumferential surface of the photosensitive drum 1, thereby suppressing leakage of toner to the outside of the developer container 72.

The end seal 732 is arranged in contact with the blade back seal 733. The blowout prevention sheet 731 extends in a longitudinal direction to a position in which the blowout prevention sheet 731 and the end seal 732 overlap each other. Accordingly, such arrangements suppress leakage of toner from the developer container 72 to the outside.

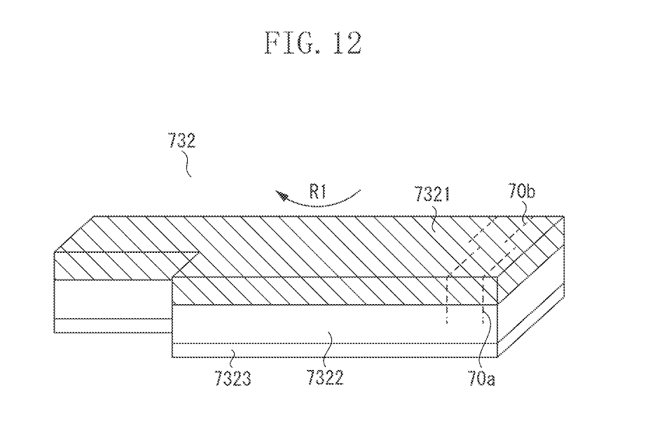

The end seal 732 is described in further detail. FIG. 12 is a diagram of the end seal 732 as seen from obliquely above. The end seal 732 includes three separate sections that are a felt implanted layer 7321, a sponge foam material layer 7322, and a double-sided adhesive sheet 7323. The double-sided adhesive sheet 7323 is bonded to a contact surface contacting a cleaning device frame. The felt implanted layer 7321 and the sponge foam material layer 7322 have both flexibility and expandability-contractibility. The felt implanted layer 7321, the sponge foam material layer 7322, and the double-sided adhesive sheet 7323 have thicknesses of 700 μm, 2000 μm, 100 μm, respectively.

Lastly, an injection seal 734 is described. Generally, the end seal 732 directly contacts the developer container 72 and the blade back seal 733, thereby suppressing leakage of toner to the outside of the developer container 72. In the present exemplary embodiment, moreover, the injection seal 734 is injected into a boundary between the developer container 72 with the blade back seal 733 and the end seal 732, thereby further enhancing toner sealability by the end seal 732. In the present exemplary embodiment, the end seal 732 and the blade back seal 733 are attached to predetermined positions of the developer container 72, and then a liquid elastomer serving as the injection seal 734 is injected. The liquid elastomer is readily solidified.

A cut part on the end seal 732 for the cleaning device 7 was studied similar to the first exemplary embodiment. The cut part as illustrated in FIG. 12 was selected for the study. Similar to the cut portions 50a and 50b on the end seal 562, cut portions 70a and 70b are formed on the end seal 732, so that an effect similar to that of the first exemplary embodiment is provided.

In the present exemplary embodiment, the developing roller 53 of the first exemplary embodiment is replaced with the photosensitive drum 1, whereas the end seal 562 of the first exemplary embodiment is replaced with the end seal 732. A configuration of the end seal 732 and a configuration (e.g., shape, position) of a cut portion formed on the end seal 732 are determined as appropriate according to the first exemplary embodiment.

In the present exemplary embodiment, one cut portion end 70a and another cut portion end 70b are respectively provided on a first end and a second end of the end seal 732 in an axial direction of the photosensitive drum 1. The one cut portion end 70a is formed by cutting halfway through a surface of the end seal 732 from the first end to the second end. The another cut portion end 70b is formed by cutting halfway through a surface of the end seal 732 from the second end to the first end. More specifically, a cutting portion is formed such that the first end and the second end of the end seal 732 are not connected in a longitudinal direction of the photosensitive drum 1.

Based on the study, in the second exemplary embodiment, similar to the first exemplary embodiment, a cut portion can be positioned in an upstream non-contact portion W11 on an upstream side relative to a contact portion in which the end seal 732 contacts the photosensitive drum 1. A cut portion may be provided on a downstream non-contact portion W12 depending on a direction in which the photosensitive drum 1 is pressed by a developing roller 53. The downstream non-contact portion W12 is positioned on a downstream side relative to the contact portion in which the end seal 732 contacts the photosensitive drum 1. Alternatively, cut portions may be provided on both of the upstream non-contact portion W11 and the downstream non-contact portion W12.

Such a configuration can suppress generation of space in a boundary area C2 (see FIG. 10) between the end seal 732 and a frame (developer container 72) of the cleaning device 7 even if a pulling force F4 is applied to the end seal 732 as illustrated in FIG. 10. Consequently, the end seal 732 can suppress leakage of toner to the outside of the cleaning device 7 for a long term.

A third exemplary embodiment is described. In the third exemplary embodiment, when a cut portion is formed on an end seal 562 to be used in a developing device 5, an appropriate angle is formed on the cut portion, so that toner leakage along the cut portion is suppressed. A description of a configuration similar to the first exemplary embodiment is omitted.

### (Evaluation of an Angle of a Cut Portion to be Formed)

Inventor of the present invention studied a suitable condition for an angle of a cut portion to be formed on the end seal 562. Such study is described as follows.

In the previous study, when a cut portion was provided on the end seal 562, there were cases where toner leaked from inside of the developer container 52 to the outside along the cut portion when the cut portion connects a first end and a second end of the end seal 562 as illustrated in FIG. 1A.

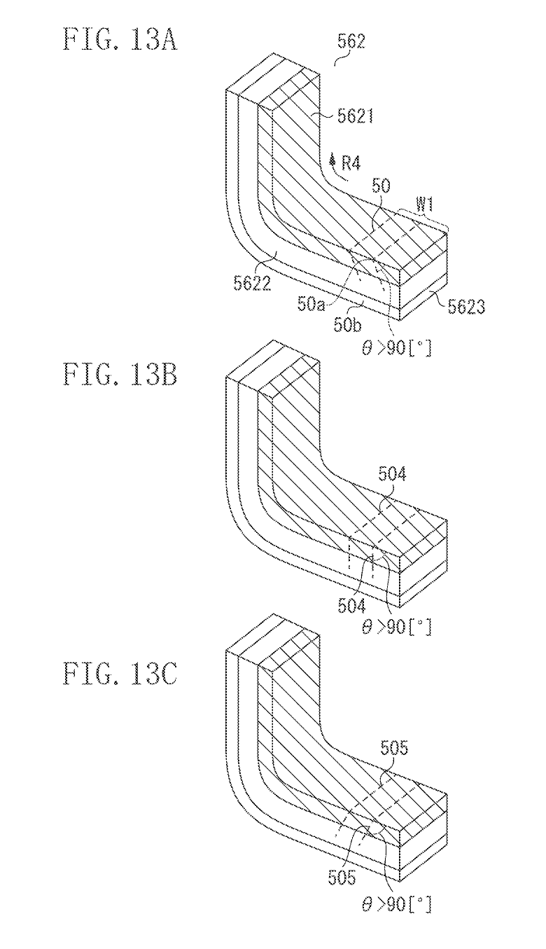

In addition to the configuration described in the first exemplary embodiment (see FIGS. 1B and 1C), an angle of a cut portion on the end seal 562 is contrived. Such contrivance is also effective to prevent the phenomenon of toner leakage. A result of the study is described in detail with reference to Table 4 and FIG. 13.

TABLE 4
Evaluation of toner leakage along a cut portion

| Cut Pattern | Toner leakage occurs along cut portion |
|---|---|
| FIG. 13A | NO |
| FIG. 13B | YES |
| FIG. 13C | YES |

NO: Toner leakage does not occur along a cut portion.
YES: Toner leakage occurs along a cut portion.

FIGS. 13A, 13B, and 13C illustrate three cut patterns used for the study. Hereinafter, cut patterns illustrated in FIGS. 13A, 13B, and 13C are referred to as cut patterns 13A, 13B, and 13C, respectively, for the sake of convenience. FIG. 13A illustrates the cut pattern 13A including a cut portion 50. FIG. 13B illustrates the cut pattern 13B including a cut portion 504 as a comparative example. FIG. 13C illustrates the cut pattern 13C including a cut portion 505 as a comparative example.

Each of the cut patterns 13A, 13B, and 13C illustrated in the respective FIGS. 13A, 13B, and 13C is provided with the cut portion which is formed by cutting a surface of the end seal 562 in a direction intersecting a rotational direction of the developing roller 53. However, each of the cut portions has a different angle. Based on the study conducted in the first exemplary embodiment, each cut portion is provided in an upstream non-contact portion W1.

Herein, when the end seal 562 and the cut portion are seen in a cross section perpendicular to an axis line of the developing roller 53, an angle toward a position on an upstream side of a rotational direction of the developing roller 53 is θ among angles formed by a surface of the end seal 562 and the cut portion.

The cut pattern 13A illustrated in FIG. 13A is assumed to have an acute angle θ formed by the cut portion 50 and the surface of the end seal 562. More specifically, on a plane perpendicular to an axis line of the developing roller 53, the cut portion 50 is formed toward an upstream side in the rotational direction of the developing roller 53 from a cut portion 50a provided on a surface of the end seal 562. Thus, a bottom 50b of the cut portion 50 is positioned on an upstream side relative to the cut portion 50a.

The cut pattern 13B illustrated in FIG. 13B is assumed to have a right angle θ formed by a cut 504 and a surface of the end seal 562 on a plane perpendicular to an axis line of the developing roller 53. In addition, the cut pattern 13C illustrated in FIG. 13C is assumed to have an obtuse angle θ formed by the cut portion 505 and a surface of the end seal 562.

The toner leakage along a cut portion is evaluated by actually attaching the end seal 562 having a cut portion to an image forming apparatus, and then checking the actual image forming apparatus after a predetermined number of sheets passed therethrough similar to the aforementioned study. In Table 4, “NO” indicates a case where toner leakage did not occur along a cut portion, whereas “YES” indicates a case where toner leakage occurred along a cut portion. As illustrated in Table 4, the cut pattern 13A illustrated in FIG. 13A is the most effective to suppress the toner leakage along the cut portion. A space in the region C (see FIG. 3) is not generated in any of these cut patterns.

In the cut pattern 13A (see FIG. 13A), the cut portion 50 is formed in a direction opposite to a rotational direction of the developing roller 53, so that the toner could not leak along the cut portion 50.

Toner carried by the developing roller 53 is moved to a downstream side in the rotation direction of the developing roller 53. However, since the cut portion 50 is formed toward an upstream side in the rotation direction of the developing roller 53 from the cut part 50a as it approaches the bottom 50b. Accordingly, the toner is unlikely to flow into the cut portion 50. Moreover, if toner flowed into the cut portion 50, the toner is moved from the cut portion 50 to an inside of the developer container 52 by a conveyance force generated by rotation of the developing roller 53. Therefore, the cut pattern 13A is considered to effectively deal with the toner leakage along the cut portion.

Consequently, the end seal 562 using the cut pattern 13A as illustrated in FIG. 13A is selected and employed in the developing device 5 (see FIG. 3). In FIG. 13A, the cut portion 50 is provided in an upstream non-contact portion of the end seal 562 such that the cut portion 50 is formed to approach an upstream side in a rotational direction of the developing roller 53 toward an inner portion (bottom 50b) of the end seal 562 from a surface (cut part 50a) of the end seal 562. As a result, a high-durability end seal capable of reducing occurrences of toner leakage is provided, and durability of the developing device is enhanced.

In the present exemplary embodiment, an injection seal 564 is injected into a boundary area between the developer container 52 and the end seal 562 as illustrated in FIG. 3, thereby blocking the space between a frame (developer container 52) of the developing device 5 and the end seal 562. However, the cut portion 50 may be formed on the end seal 562 even if the injection seal 564 is not used.

In a fourth exemplary embodiment, a cut portion on an end seal 562 is formed to be inclined, and does not connect a first end 562a and a second end 562b of the end seal 562 in a longitudinal direction of a developing roller 53. In the present exemplary embodiment, the end seal 562 includes a cut portion having both of features described in the first and third exemplary embodiments. In the following description, components having similar effects and similar configurations as the first and third exemplary embodiments are given the same reference numerals as above and description thereof will be omitted.

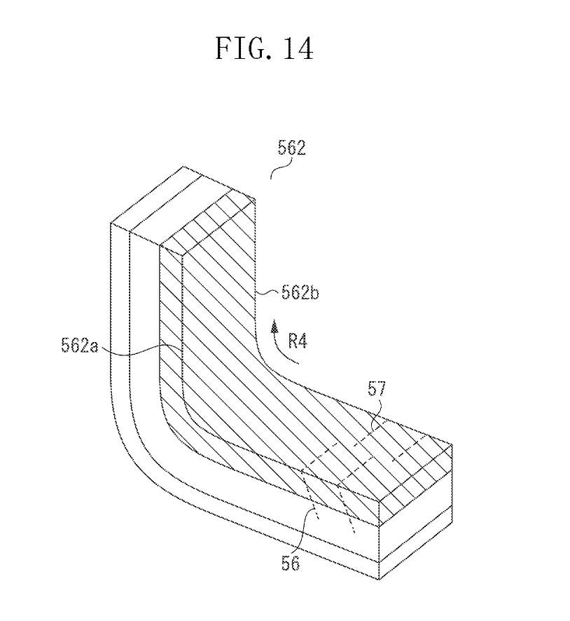

In the present exemplary embodiment, a cut portion is provided only on an end of the end seal 562 as illustrated in FIG. 14 to suppress toner leakage along the cut portion to the outside of the developing device 5. More specifically, the end seal 562 includes one cut portion end 56 formed by cutting halfway through a surface of the end seal 562 from a first end 562a to a second end 562b. Moreover, the end seal 562 includes another cut portion end 57 formed by cutting halfway through a surface of the end seal 562 from the second end 562b to the first end 562a.

As for both ends of the end seal 562 in a longitudinal direction of the developing roller 53, assume that an end on a side near a middle portion of the developing roller 53 is the first end 562a and an end on an opposite side is the second end 562b.

In the present exemplary embodiment, since the one cut portion end 56 and another cut portion end 57 do not connect the first end 562a and the second end 562b of the end seal 562, toner leakage along a cut portion to the outside of a developer container 52 can be suppressed.

The one cut portion end 56 provided on a side near (a side near a middle portion of the developing roller 53) an opening O1 of the developer container 52 (see FIG. 4) is inclined such that a bottom thereof is oriented toward an upstream side of a rotational direction of the developing roller 53. Such an arrangement can more reliably suppress a movement of toner from the inside to the outside of the developer container 52 along the one cut portion end 56 similar to the cut portion 50 in the first exemplary embodiment.

Since toner carried by the developing roller 53 rarely flows into the another cut portion end 57 on a side far from the opening O1 of the developer container 52, an angle of the another cut portion end 57 is not particularly defined in the present exemplary embodiment. However, the another cut portion end 57 may be inclined such that a bottom thereof is oriented toward an upstream side of a rotational direction of the developing roller 53 similar to the one cut portion end 56. Herein, such an arrangement can further suppress toner leakage along another cut portion end 57 to the outside of the developer container 52.

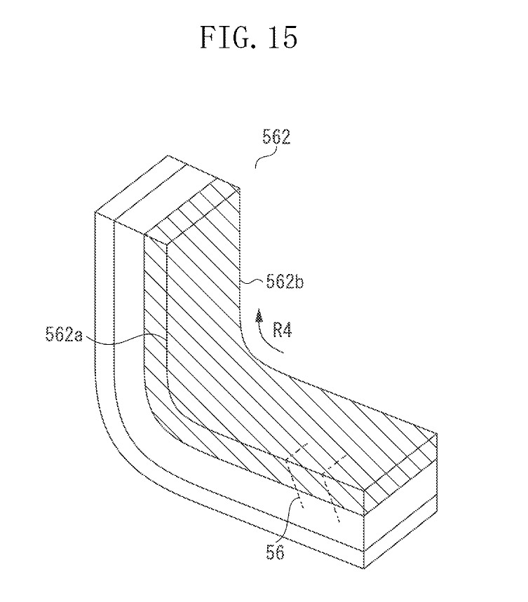

Further, the present exemplary embodiment can be modified. For example, only one cut portion end 56 can be provided on an end seal 562 as illustrated in FIG. 15. However, an arrangement of both of the one cut portion end 56 and the another cut portion end 57 as illustrated in FIG. 14 is more effective than that illustrated in FIG. 15 from a standpoint of not propagating an end seal pulling force F1 to a region C (FIG. 3). Thus, whether the another cut portion end 57 is to be provided on the end seal 562 can be properly selected according to strength of the pulling force F1.

A fifth exemplary embodiment using an end seal of the present invention is described. The third and fourth exemplary embodiments are described to have an inclined cut portion provided on the end seal 562 of the developing device 5. In the present exemplary embodiment, a cut portion similar to that described in the third and fourth exemplary embodiments is provided on an end seal 732 of a cleaning device 7.

A configuration and an image forming operation of an image forming apparatus according to the present exemplary embodiment are similar to those of the image forming apparatus according to the first exemplary embodiment. The cleaning device 7 according to the present exemplary embodiment is similar to that described in the second exemplary embodiment.

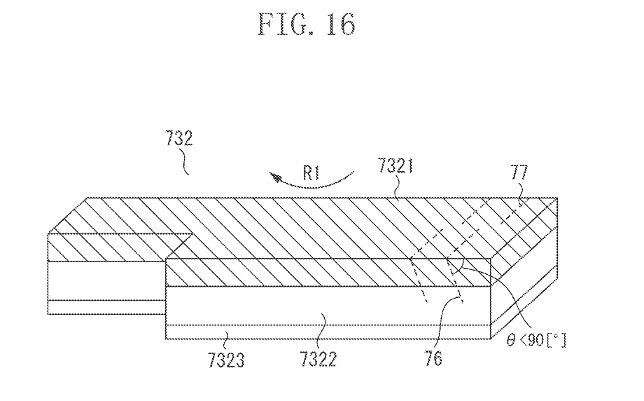

In the present exemplary embodiment, a cut portion on the end seal 732 for the cleaning device 7 was studied similar to the third and fourth exemplary embodiments. The cut portion as illustrated as FIG. 16 was selected for the study. Cut portions 76 and 77 similar to the cut portions 56 and 57 on the end seal 562 are formed on the end seal 732, so that an effect similar to that of the second exemplary embodiment is provided.

In the present exemplary embodiment, the developing roller 53 in each of the third and fourth exemplary embodiments is replaced with a photosensitive drum 1, and the end seal 562 is replaced with the end seal 732. A configuration of the end seal 732 and a configuration (e.g., shape, position) of a cut portion formed on the end seal 732 are determined as appropriate according to the end seal 562 of the third and fourth exemplary embodiments.

In the present exemplary embodiment, one cut portion end 76 and another cut portion end 77 are respectively provided on a first end and a second end of the end seal 732 in an axial direction of the photosensitive drum 1. The one cut portion end 76 is formed by cutting halfway through a surface of the end seal 732 from the first end to the second end. The another cut portion end 77 is formed by cutting halfway through a surface of the end seal 732 from the second end to the first end. The one cut portion end 76 and the another cut portion end 77 are formed in a upstream non-contact portion W11 (see FIG. 10) positioned on an upstream side relative to a contact portion in which the end seal 732 contacted the photosensitive drum 1.

Moreover, the one cut portion end 76 provided near a middle portion of the photosensitive drum 1 is inclined toward an upstream side in a rotational direction of the photosensitive drum 1 from a cut formed on a surface of the end seal 732.

Based on the study, therefore, such a configuration can suppress generation of space in a boundary area C2 between the end seal 732 and a frame (developer container 72) of the cleaning device 7 even if a pulling force F4 is applied to the end seal 732 as illustrated in FIG. 10. Consequently, the end seal 732 can suppress leakage of toner to the outside of the cleaning device 7 for a long term.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application Nos. 2011-219361 filed Oct. 3, 2011 and 2011-219362 filed Oct. 3, 2011, which are hereby incorporated by reference herein in their entirety.

What is claimed is:

1. A developing device for developing a latent image, the developing device comprising:
a developer bearing member configured to bear a developer;
a frame member configured to rotatably support the developer bearing member; and
a sealing member provided on the frame member, including a contact portion configured to contact an end in an axial direction of the developer bearing member and a non-contact portion configured not to contact the developer bearing member, the sealing member including a cut portion provided in the non-contact portion by cutting a surface of the sealing member in a direction intersecting a rotational direction of the developer bearing member,
wherein the cut portion does not connect one end and another end of the sealing member in the axial direction.

2. The developing device according to claim 1, wherein the sealing member includes one cut portion end and another cut portion end as the cut portion, the one cut portion end being provided by cutting halfway through the surface of the sealing member from the one end to the another end and another cut portion end being provided by cutting halfway through the surface of the sealing member from the another end to one end.

3. The developing device according claim 2, wherein the one cutting portion end and another cutting portion end are provided at different positions in the rotational direction of the developer bearing member.

4. The developing device according to claim 1, wherein the sealing member includes an upstream non-contact portion positioned on an upstream side relative to the contact portion in the rotational direction, and
wherein the cut portion is formed in the upstream non-contact portion.

5. The developing device according to claim 4, wherein the sealing member includes a downstream non-contact portion positioned on a downstream side relative to the contact portion in the rotational direction, and
wherein the cut portion is also formed in the downstream non-contact portion.

6. A developing device for developing a latent image, the developing device comprising:
a developer bearing member configured to bear a developer;
a frame member configured to rotatably support the developer bearing member; and
a sealing member provided on the frame member, including a contact portion configured to contact an end in an axial direction of the developer bearing member and a non-contact portion configured not to contact the developer bearing member, the sealing member including a cut portion provided in the non-contact portion by cutting a surface of the sealing member in a direction intersecting a rotational direction of the developer bearing member,
wherein the cut portion is formed to approach an upstream side of the rotational direction from the surface of the sealing member toward an inner portion of the sealing member.

7. The developing device according to claim 6, wherein the cut portion does not connect one end and another end of the sealing member in the axial direction.

8. The developing device according to claim 7, wherein the cut portion is one cutting portion end provided by cutting halfway through the surface of the sealing member from the one end to the another end of the sealing member in the axial direction, and
wherein the one end is an end provided on a side closer to a middle portion of the developer bearing member in the axial direction than the another end.

9. The developing device according to claim 8, wherein the sealing member further includes another cut portion end provided by cutting halfway through the surface of the sealing member from the another end to the one end.

10. The developing device according to claim 6, wherein the sealing member includes an upstream non-contact portion positioned on an upstream side relative to the contact portion in the rotational direction as the non-contact portion, and
wherein the cut portion is formed in the upstream non-contact portion.

11. A cleaning device including an image bearing member and removing a developer attached to the image bearing member, the cleaning device comprising:
a frame member configured to rotatably support the image bearing member; and
a sealing member provided on the frame member, including a contact portion configured to contact an end in an axial direction of the image bearing member and a non-contact portion configured not to contact the image bearing member, the sealing member including a cut portion provided in the non-contact portion by cutting halfway through a surface of the sealing member in a direction intersecting a rotational direction of the image bearing member,
wherein the cut portion does not connect one end and another end of the sealing member in the axial direction.

12. The cleaning device according to claim 11, wherein the sealing member includes one cut portion end and another cut portion end as the cut portion, the one cut portion end being provided by cutting halfway through the surface of the sealing member from the one end to the another end and another cut portion end being provided by cutting halfway through the surface of the sealing member from the another end to the one end.

13. The cleaning device according to claim 12, wherein the one cut portion end and another cut portion end are provided in different positions in the rotational direction of the image bearing member.

14. The cleaning device according to claim 11, wherein the sealing member includes an upstream non-contact portion positioned on an upstream side relative to the contact portion in the rotational direction, and
wherein the cut portion is formed in the upstream non-contact portion.

15. The cleaning device according to claim 14, wherein the sealing member includes a downstream non-contact portion positioned on a downstream side relative to the contact portion in the rotational direction as the non-contact portion, and
wherein the cut portion is also formed in the downstream non-contact portion.

16. A cleaning device including an image bearing member and removing a developer attached to the image bearing member, the cleaning device comprising:
a frame member configured to rotatably support the image bearing member; and
a sealing member provided on the frame member, including a contact portion configured to contact an end in an axial direction of the image bearing member and a non-contact portion configured not to contact the image bearing member, the sealing member including at least one cut portion provided in the non-contact portion by cutting a surface of the sealing member in a direction intersecting a rotational direction of the image bearing member,
wherein the cut portion is formed to approach an upstream side of the rotational direction from the surface of the sealing member toward an inner portion of the sealing member.

17. The cleaning device according to claim 16, wherein the cut portion does not connect one end and another end of the sealing member in the axial direction.

18. The cleaning device according to claim 17, wherein the cut portion is one cut portion end provided by cutting halfway through the surface of the sealing member from the one end to the another end of the sealing member in the axial direction, and
wherein the one end is an end provided on a side closer to a middle portion of the image bearing member in the axial direction than the another end.

19. The cleaning device according to 18, wherein the sealing member further includes another cut portion end provided by cutting halfway through the surface of the sealing member from the another end to the one end.

20. The cleaning device according to claim 16, wherein the sealing member includes an upstream non-contact portion positioned on an upstream side relative to the contact portion in the rotational direction, and
wherein the cut portion is formed in the upstream non-contact portion.
